(19) United States
(12) Patent Application Publication
(10) Pub. No.: US 2010/0061687 A1
(43) Pub. Date: Mar. 11, 2010

(54) CONSOLE FOR A DISTRIBUTING DEVICE FOR OPTICAL WAVEGUIDE CABLES

(75) Inventors: Ulrich Hetzer, Berlin (DE); Frank Mossner, Berlin (DE); Ferenc Nad, Berlin (DE)

Correspondence Address: MERCHANT & GOULD PC, P.O. BOX 2903, MINNEAPOLIS, MN, 55402-0903, US

(73) Assignee: ADC GmbH, Berlin (DE)

(21) Appl. No.: 12/528,698

(22) PCT Filed: Feb. 15, 2008
(86) PCT No.: PCT/EP08/01154

§ 371 Date: Aug. 26, 2009

(30) Foreign Application Priority Data
Mar. 1, 2007 (DE) 10 2007 010 854.2

(51) Int. Cl. G02B 6/44; G02B 6/00

(52) U.S. Cl. 385/100; 385/135

(57) ABSTRACT

The invention relates to a console for a distribution device for optical waveguide cables the console (4) consisting of plastic, the console comprising an upper side (44), a lower side (41) and side faces, and at least one angled sheet-metal part (48) being arranged on one side face.

The invention relates to a console for a distribution device for optical waveguide cables.

Optical waveguide cables generally comprise a central element as the supporting structure and a large number of bundle cores. The optical waveguide cable may be subjected to external forces, the central element generally absorbing all longitudinal forces. A bundle core in turn comprises a number of optical waveguide fibers having a common sheathing. Optical waveguide fibers have a certain degree of sensitivity to moisture, which changes the transmission response of the fibers. Plastics are only capable to a restricted extent of suppressing the diffusion of moisture. Optical waveguide cables are therefore known which have a metal foil, preferably an aluminum foil, as diffusion protection against moisture beneath the outer cable sheathing. This metal or aluminum foil may be at an unspecified electrical potential owing to external electromagnetic fields and therefore needs to be grounded.

The invention is therefore based on a technical problem of providing a console for a distribution device for optical waveguide cables, by means of which a flexible mechanical and, if necessary, electrical connection of the metallic sheathing of an optical waveguide cable is made possible.

The technical problem is solved by the subject matter having the features of claim 1. Further advantageous configurations of the invention are given in the dependent claims.

In this regard, the console for a distribution device for optical waveguide cables which consists of plastic comprises an upper side, a lower side and side faces, at least one angled sheet-metal part being arranged on a side face. Then, an optical waveguide cable can be connected mechanically, for example by means of a clip, via this angled sheet-metal part in a simple manner.

An arrangement on a side face is therefore also not to be understood as it bearing completely against the side face, but the angled sheet-metal part being spaced apart from the side face at least at one point.

In a preferred embodiment, the angled sheet-metal part is screwed to the upper side of the console.

In a preferred embodiment, the angled sheet-metal part is connected to the ground plate, which is arranged on the upper side of the console. The angled sheet-metal part can in this case be designed to be integral with the ground plate or else can be connected to it via a screw connection, for example. The ground plate preferably covers the upper side of the console completely.

In a further preferred embodiment, the angled sheet-metal part is designed with a desire bending point which is preferably realized via a taper. The desired bending point is in this case further preferably arranged in the direct vicinity of the upper side of the console in order to achieve a maximum bending distance. Owing to the desired bending point, the mechanically fixed optical waveguide cable can be bent back outwards in a defined manner, for example in order to replace defective lower parts of a housing.

In a further preferred embodiment, a fixing element for fixing a central element of an optical waveguide cable is arranged on the angled sheet-metal part. Preferably, the fixing element comprises a jaw having an indentation or notch and a plate which can be screwed.

In a further preferred embodiment, pedestal feet, which have holes, are arranged on the lower side of the console. As a result, the console can be screwed detachably to a housing lower part by means of a screw connection, which also makes it possible to replace defective housing lower parts in addition to a modular design.

In a further preferred embodiment, a ground strip is fixed to the upper side of the console, which ground strip is used for the electrical connection to an aluminum foil of an optical waveguide cable. Preferably, in this case the ground strip is screwed to the angled sheet-metal part and the console. Further preferably, the ground strip is in this case bent such that it bears against the optical waveguide cable on the side opposite the angled sheet-metal part.

In a further preferred embodiment, the upper side of the console has a round central region, from which rests protrude in the form of a star. Owing to the rests, the angled sheet-metal part is supported on the upper side of the console and has a distance from the side faces of the console, with the result that fixing between the optical waveguide cable and the angled sheet-metal part is simplified. The number of rests in this case corresponds to the number of optical waveguide cables to be fixed.

In a further preferred embodiment, a fixing limb, which is used for connection to a carrier system, is arranged on the upper side of the console. In this case, the fixing limb is preferably screwed to the ground plate and console.

Application fields of the console according to the invention are distribution devices for optical waveguide cables, such as sleeves, cable splitters or sealing ends, for example.

The invention will be explained in more detail below with reference to a preferred exemplary embodiment. In the figures:

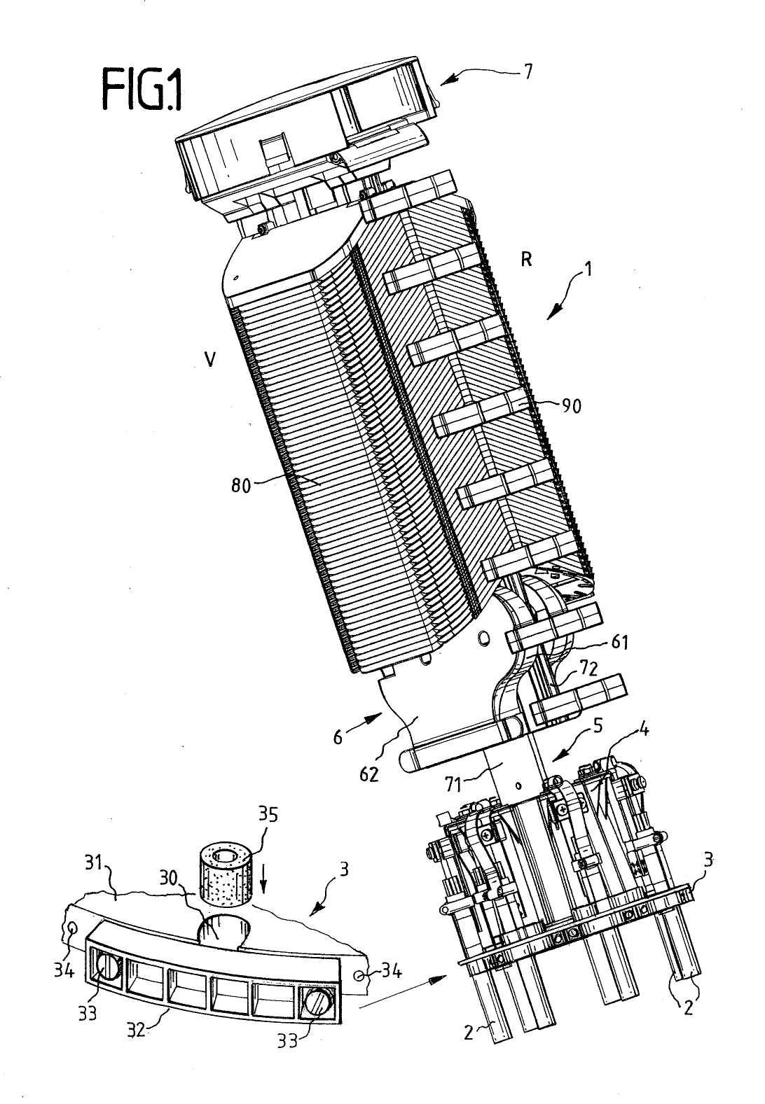

FIG. 1 shows a perspective front view of a sleeve for optical waveguide cables without a housing upper part,

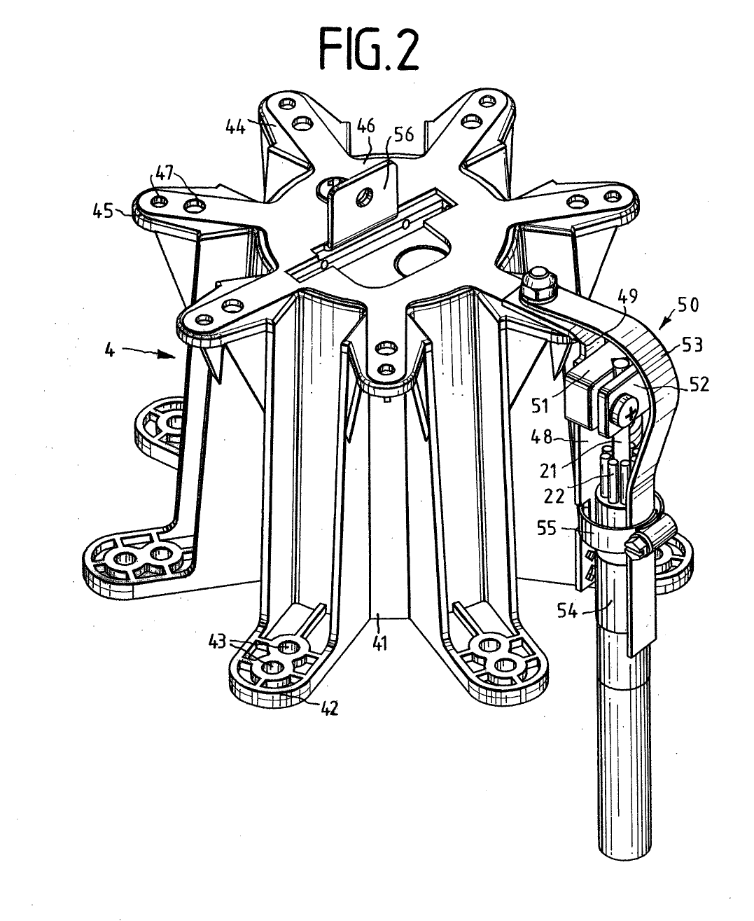

FIG. 2 shows a perspective illustration of a console with a ground plate,

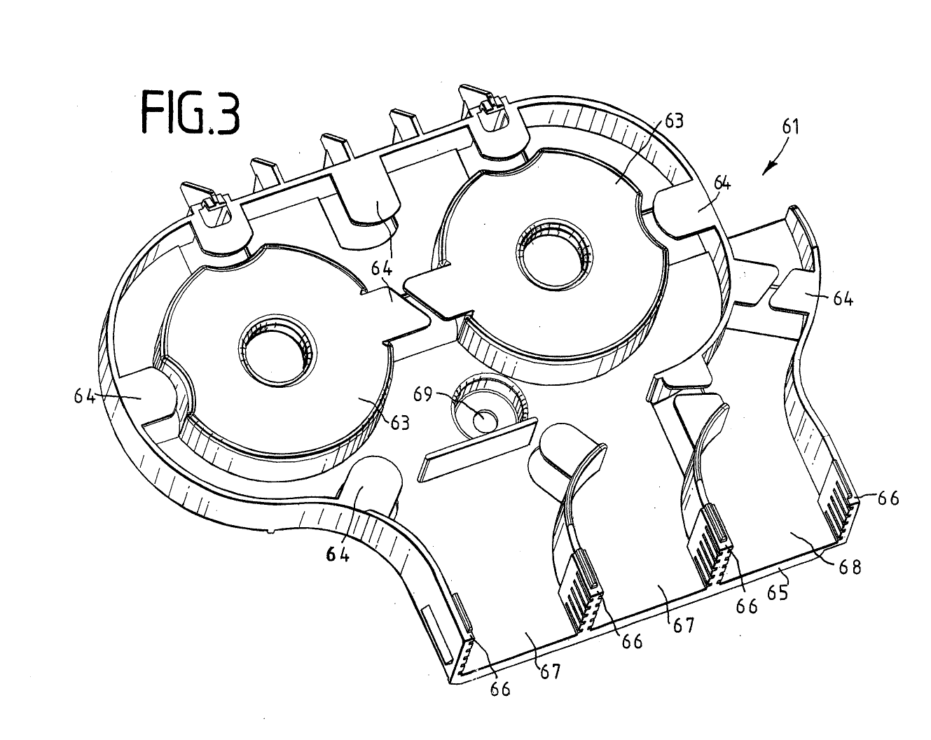

FIG. 3 shows a perspective front view of a part of the fiber management unit,

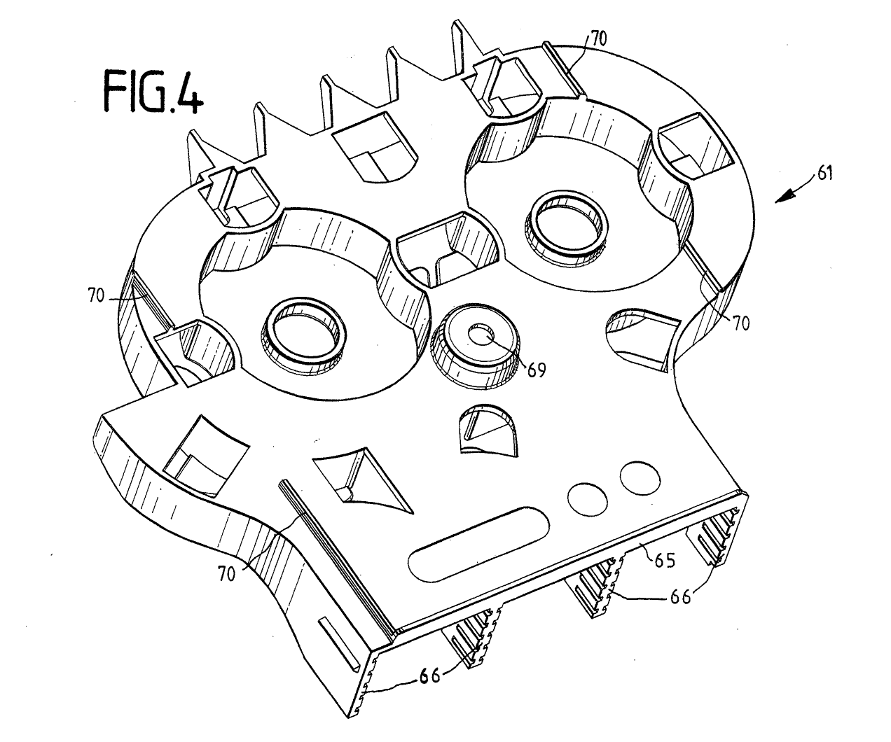

FIG. 4 shows a perspective rear view of the part shown in FIG. 3,

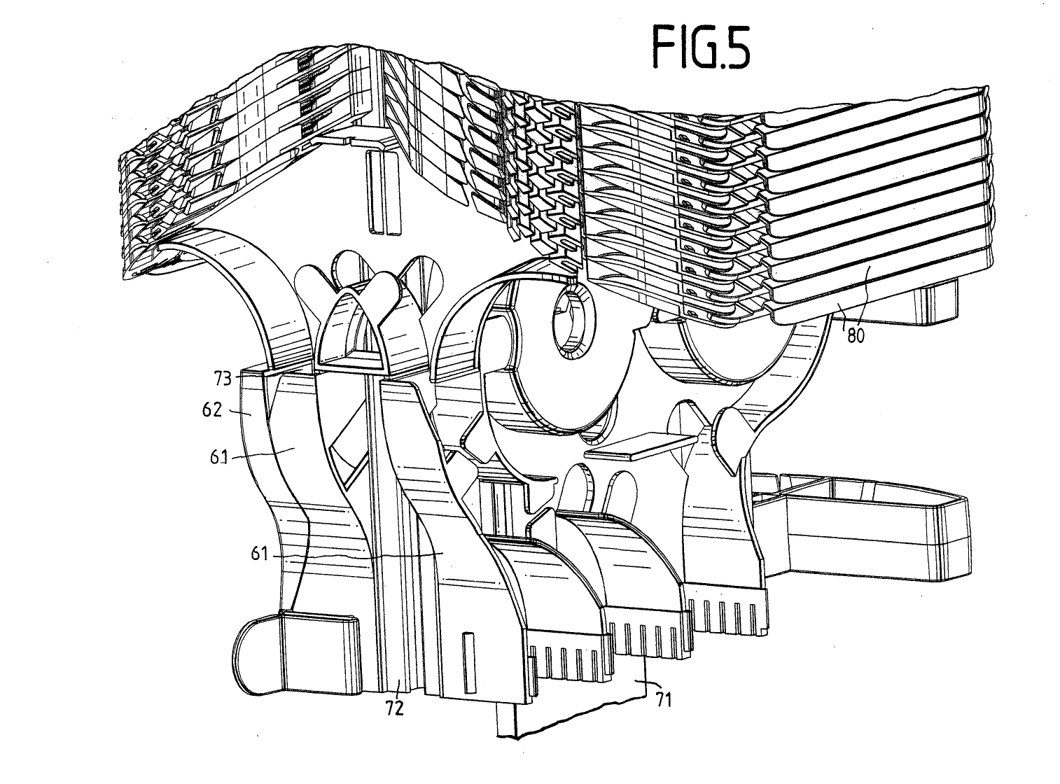

FIG. 5 shows a perspective side view of the fiber management unit,

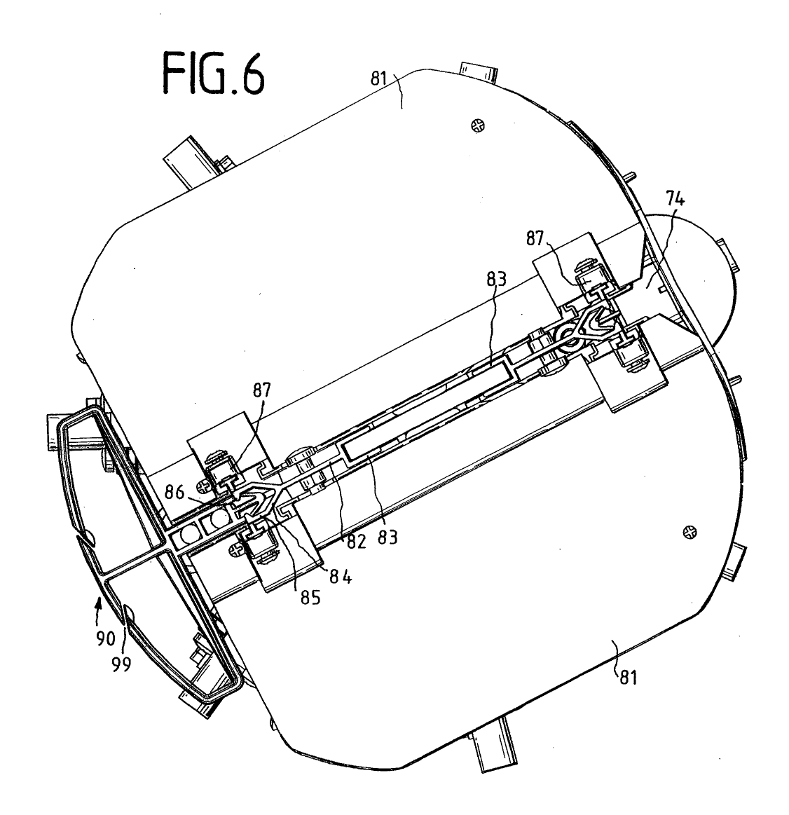

FIG. 6 shows a plan view of the sleeve with the bundle core repository removed,

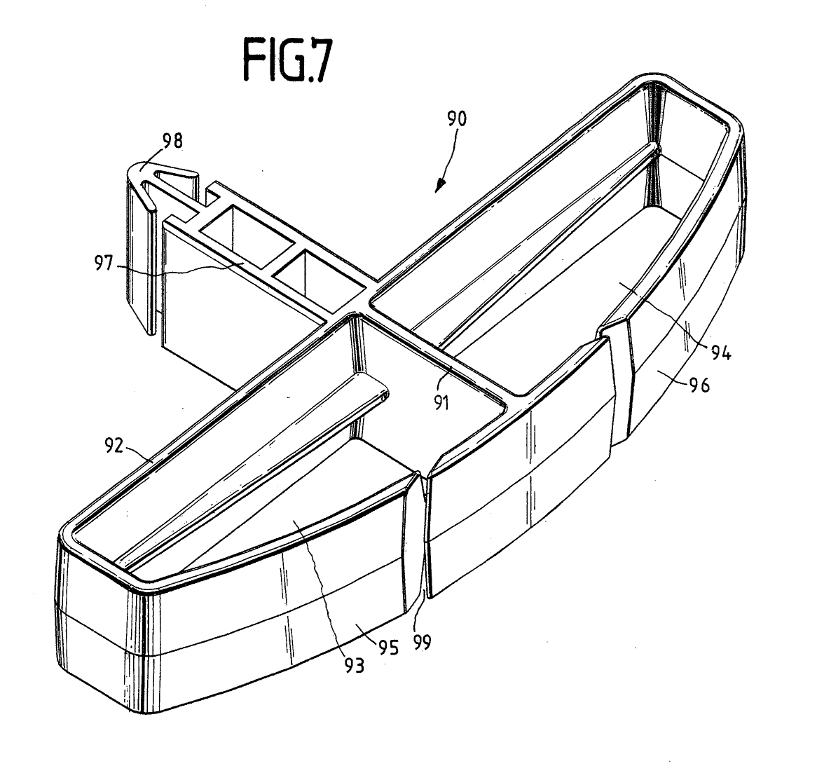

FIG. 7 shows a perspective illustration of a bundle core guide,

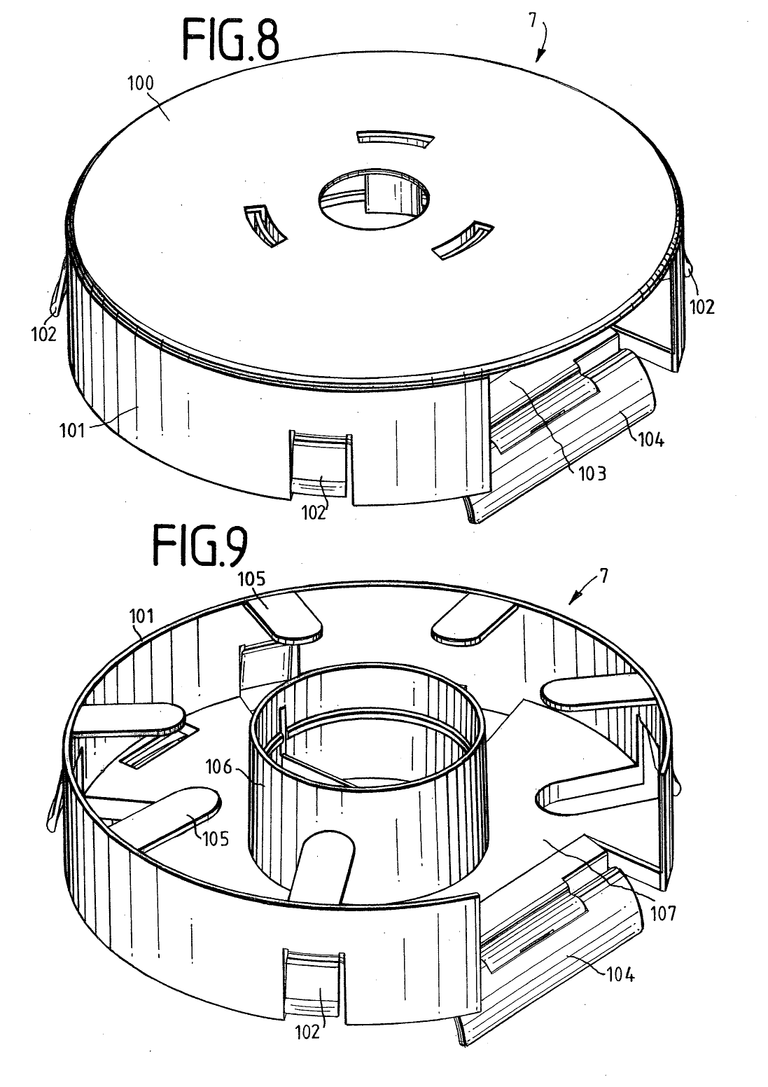

FIG. 8 shows a perspective illustration of a bundle core repository,

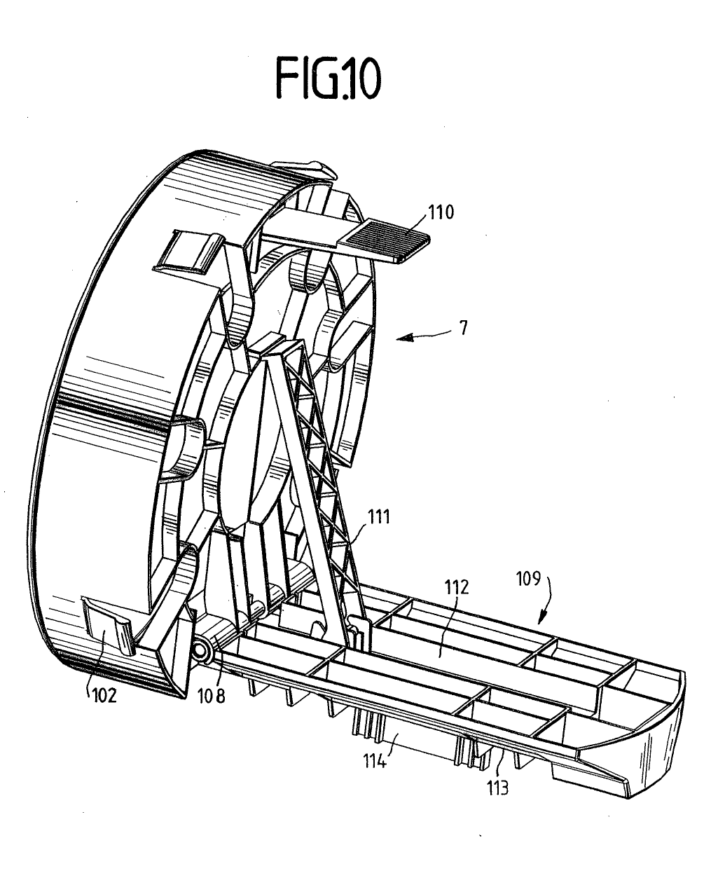

FIG. 9 shows a perspective illustration of the bundle core repository without the cover,

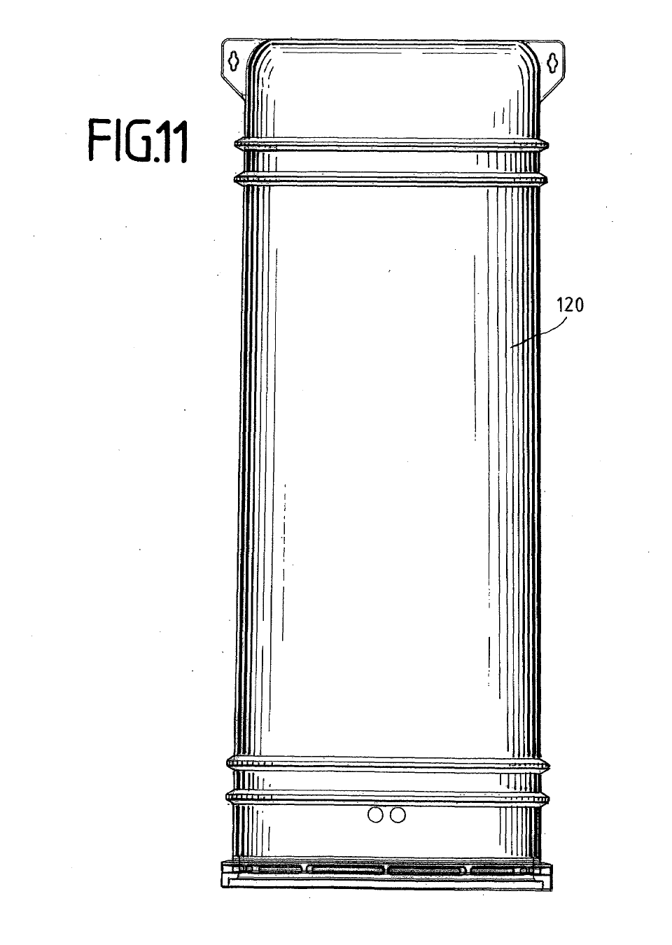

FIG. 10 shows a perspective view from below of the bundle core repository in the pivoted-up state, and

FIG. 11 shows a side view of a housing upper part.

FIG. 1 illustrates a sleeve 1 for optical waveguide cables 2 without a housing upper part 120 (see FIG. 11). The sleeve comprises a housing lower part 3, a console 4, a carrier system 5, a fiber management unit 6 and a bundle fiber repository 7. The housing lower part 3 is formed with openings 30 for optical waveguide cables 2, which are sealed off from moisture via sealing elements 35. In this case, the housing lower part 3 is designed to have two or more parts, lateral circumferential parts 32 of the housing lower part 3, including edge parts of the openings 30, being fixed detachably on a base plate 31, preferably by means of screws 33, which are screwed into a thread 34 of the base plate 31. Preferably, as many circumferential parts 32 are arranged detachably as openings 30 for optical waveguide cables 2 are provided, precisely one opening 30 being exposed laterally or radially by each circumferential part 32.

First, the manner in which the optical waveguide cables 2 are connected will be explained with reference to FIG. 2. The console 4 which consists of plastic has a star-shaped cross section and is formed on the lower side 41 with pedestal feet 42, which have holes 43. The console 4 can then be screwed to the housing lower part 3 by means of screws, which are not illustrated. The upper side 44 has a round central region, from which seven rests 45 protrude in the form of a star. A ground plate with holes 47, which are aligned with openings in the rests 45, is formed on the upper side 44. In each case one angled sheet-metal part 48, which has a desired bending point 49 in the form of a tapered portion, is screwed onto the ground plate 46. A fixing element 50 for fixing a central element 21 of the optical waveguide cable 2 is arranged on the angled sheet-metal part 48. The fixing element 50 comprises a jaw 51 with an indentation and a plate 52 which can be screwed. In the example illustrated, a connection of the optical waveguide cable 2 to ground is illustrated by a ground strip 53, which is screwed to the angled sheet-metal part 48 and the console 4. The ground strip 53 is in this case bent such that it bears against the optical waveguide cable 2 on the side opposite the angled sheet-metal part 48. A connection to ground in the case of optical waveguide cables 2 is usually used when said optical waveguide cables are formed with a metal foil as diffusion protection against moisture. For this purpose, the outer sheathing of the optical waveguide cable 2 is then partially removed and the metal foil exposed. Then, a scroll spring 54 is wound onto the exposed metal foil and the ground strip 53, which scroll spring 54 then presses the ground strip 53 in a sprung manner against the metal foil and therefore then connects them electrically to one another (which is not illustrated in FIG. 2). The ground strip 53 is then screwed to the angled sheet-metal part 48 and the ground plate 46, the ground connection then being guided outwards via a connection (not illustrated) to the screws 33 of the lower part 3. Furthermore, the angled sheet-metal part 48 and the optical waveguide cable 2 are connected mechanically to one another via a clip 55, with the result that the optical waveguide cable 2 is fixed mechanically. Furthermore, a plurality of bundle cores 22 are illustrated in FIG. 2 which are arranged around the central element 21. Bundle cores 22 comprise a plurality of fibers having a common sheathing. For reasons of clarity, the bundle cores 22 are in this case illustrated such that they are cut away, whereas they are actually guided upwards. Furthermore, a fixing limb 56 is illustrated, to which a central carrier 71 of the carrier system 5 is screwed. A defective housing lower part 3 can be replaced by means of the desired bending point 49 and the detachable circumferential parts 32 of the housing lower part 3 without optical waveguide connections in the sleeve 1 being separated. For this purpose, the circumferential parts 32 of the housing lower part 3 are detached where optical waveguide cables 2 are connected. Then, the optical waveguide cables 2 are bent away at an angle to the side via the desired bending point 49, and the defective housing lower part 3 is removed. A reverse procedure is correspondingly used for mounting a new housing lower part 3.

FIG. 3 illustrates a fiber guide 61 of the fiber management unit 6, which is hidden in FIG. 1 by a covering 62. As illustrated in FIG. 1, a fiber guide 61 is arranged on the front side V of the carrier system 5 and a fiber guide 61 is arranged on the rear side R of the carrier system 5. The fiber guide 61 comprises two coil formers 63 and a plurality of retainers 64. Guide webs 66, which form guides 67, 68, are arranged on a lower side 65, which faces the console 4. If it is now intended for individual fibers of a bundle core 22 to be connected to another optical waveguide cable 2, the bundle core is cut. The end of the bundle cores is fixed in the region 67 and 68 in a part not illustrated. The fibers, which are intended to be connected to another optical waveguide cable 2, are supplied via the guide 68 to one or more splicing cassettes 80, which are arranged above the fiber management unit 6 on the front side V and rear side R of the carrier system 5. In this case, both the incoming fiber and the outgoing fiber are guided in the guide 68. The remaining fibers of a bundle core 22, which are not intended to be connected to another optical waveguide cable 2, but are intended to be looped through, are guided into the guide 67. There, the necessary reserve length or splicing reserve is wound onto the coil formers 63, and then these fibers are guided out of the other guide 67 back to the optical waveguide cable 2. In the center, the fiber guide 61 has an opening 69, through which the fiber guide 61 can be screwed to the central carrier 71 of the carrier system 5.

FIG. 4 illustrates the rear side of the fiber guide 61, which bears against the carrier system 5. In this case, the fiber guide 61 has four stop edges 70, which stop against edges of the carrier system 5 and therefore prevent the fiber guide 61 from tipping.

FIG. 5 illustrates the fiber management unit 6 in a side view. The two fiber guides 61 for the front side V and the rear side R are screwed to the central carrier 71 of the carrier system 5, the stop edges 70 stopping against stop edges of two profiled carriers 72, which are connected to the central carrier 71, the rear profiled carrier 72 being hidden in the illustration. A lateral fiber guide 74, which allows for the fibers to jump laterally from the front side V to the rear side R of the sleeve 1 are arranged laterally on the upper side 73 of the fiber guides 61 for the front side V and the rear side R. The lateral fiber guide 74 can in this case be a separate component or else one half can in each case be connected integrally to the fiber guides 61 for the front side V and rear side R.

FIG. 6 illustrates a plan view of the sleeve 1 with the bundle core repository 7 removed. In this case, coverings 81 for the splicing cassettes 80 are illustrated. The profiled carriers 72 have a central plate-shaped region 82, which is adjoined by a U-shaped region 83. The other side is adjoined by a region 84, which is initially in the form of a V, in this case the limbs 85 running parallel and having inwardly pointing bent-back portions 86. The splicing cassettes 80 are pushed onto the profiled carriers 72 from above. Then, the covering 81 is pushed over the last, uppermost splicing cassette 80 and fixed via stoppers 87, which can be screwed. Bundle core guides 90 are inserted into the region 84 of the left-hand profiled carrier. For example, the lateral fiber guide 74 is inserted on the other profiled carrier 72.

The bundle core guide 90 comprises a central web 91, which splits an outer edge 92 into two guides 93, 94 (see FIG. 7). In this case, the outer edge 92 is formed at in each case one of the guides 93, 94 with a cut-free portion 99, with the result that the parts 95, 96 of the outer edge 92 are sprung. This makes it possible to insert the bundle cores 22 laterally. The bundle core guide 90 is formed with a shaft 97 as an extension of the central web 91, an arrow-shaped attachment 98 being arranged at the end of said shaft 97. If the bundle core guide 90 is then plugged into the profiled carrier 72, the arrow-shaped attachment 98 latches behind the bent-back portion 86 of the profiled carrier 72. Owing to the design with two guides 93, 94, a clearly separated split between the bundle core 22 being guided towards the bundle core repository 7 and the bundle core 22 being guided back can be achieved.

FIG. 8 illustrates the bundle core repository 7. The bundle core repository 7 has a substantially cylindrical shape, which is closed towards the top by a removable cover 100. Three sprung props 102 are cut free from the outer face 101, press in a sprung manner against the turned-over housing upper part 120 and therefore stabilize the bundle core repository 7. Furthermore, the bundle core repository 7 has an opening 103, beneath which a rounded-off portion 104 is arranged.

FIG. 9 illustrates the bundle core repository 7 without the cover 100. Retainers 105 are arranged on the inner sides of the outer face 101. Furthermore, a winding cylinder 106 is arranged centrally on a bottom face 107. The bundle cores 22 are guided by the bundle core guides 90 to the bundle core repository 7 and inserted through the opening 103, wound around the winding cylinder 106 and then guided out again through the opening 103. The bundle core repository 7 therefore makes it possible for reserve lengths of uncut bundle cores 22, which are only looped through the sleeve 1, to be deposited centrally in ordered fashion.

FIG. 10 illustrates the bundle core repository 7 in a pivoted-up state. For this purpose, the bundle core repository 7 can be pivoted through approximately 90° with respect to a lower part 109 via a pivot bearing 108. The lower part 109 is latched to the carrier system 5. The bundle core repository is formed with a latching hook 110 on the lower side, which latching hook 110 latches with the lower part 109 in the initial position (see FIG. 1). In the pivoted-up position, the bundle core repository 7 is held by a latched-in consoleing strut 111 and is propped against the lower part 109. The consoleing strut 111 dips into a reciprocal 112 in the initial position. By means of a plug-type rail 114, which is arranged on a lower side 113 of the lower part 109, the lower part 109 with the bundle core repository 7 can then be plugged onto the upper side of the carrier system 5, the plug-type rail 114 latching in between the two U-shaped regions 83 of the profiled carriers 72.

FIG. 11 illustrates a side view of a housing upper part 120, which is consoleed on the sleeve 1 from above and is connected to the housing lower part 3.

List of reference symbols

| | |
|---|---|
| 1 | Sleeve |
| 2 | Optical waveguide cable |
| 3 | Housing lower part |
| 4 | Console |
| 5 | Carrier system |
| 6 | Fiber management unit |
| 7 | Bundle fiber repository |
| 21 | Central element |
| 22 | Bundle core |
| 30 | Opening |
| 31 | Base plate |
| 32 | Circumferential part |
| 33 | Screw |
| 34 | Thread |
| 35 | Sealing element |
| 41 | Lower side |
| 42 | Pedestal feet |
| 43 | Holes |
| 44 | Upper side |
| 45 | Rests |
| 46 | Ground plate |
| 47 | Holes |
| 48 | Angled sheet-metal part |
| 49 | Desired bending point |
| 50 | Fixing element |
| 51 | Jaw |
| 52 | Plate |
| 53 | Ground strip |
| 54 | Scroll spring |
| 55 | Clip |
| 56 | Fixing limb |
| 61 | Fiber guide front side/rear side |
| 62 | Covering |
| 63 | Coil former |
| 64 | Retainer |
| 65 | Lower side |
| 66 | Guide webs |
| 67, 68 | Guides |
| 69 | Opening |
| 70 | Stop edges |
| 71 | Central carrier |
| 72 | Profiled carrier |
| 73 | Upper side |
| 74 | Lateral fiber guide |
| 80 | Splicing cassette |
| 81 | Coverings |
| 82 | Plate-shaped region |
| 83 | U-shaped region |
| 84 | V-shaped region |
| 85 | Limb |
| 86 | Bent-back portions |
| 87 | Stopper |
| 90 | Bundle core guides |
| 91 | Central web |
| 92 | Edge |
| 93, 94 | Guides |
| 95, 96 | Parts |
| 97 | Shaft |
| 98 | Arrow-shaped attachment |
| 99 | Cut-free portion |
| 100 | Cover |
| 101 | Outer face |
| 102 | Props |
| 103 | Opening |
| 104 | Rounded-off portion |
| 105 | Retainer |
| 106 | Winding cylinder |
| 107 | Bottom face |
| 108 | Pivot bearing |
| 109 | Lower part |
| 110 | Latching hook |
| 111 | Consoleing strut |
| 112 | Reciprocal |
| 113 | Lower side |
| 114 | Plug-type rail |
| 120 | Housing upper part |
| V | Front side |
| R | Rear side |

1) A console for a distribution device for optical waveguide cables, wherein the console consists of plastic, the console comprising an upper side, a lower side and side faces, and at least one angled sheet-metal part being arranged on one side face.

2) The console as claimed in claim 1, wherein the angled sheet-metal part is screwed to the upper side of the console.

3) The console as claimed in claim 1, wherein the angled sheet-metal part is connected to a ground plate, which is arranged on the upper side of the console.

4) The console as claimed in claim 1, wherein the angled sheet-metal part has a desired bending point.

5) The console as claimed in claim 1, wherein a fixing element for fixing a central element of an optical waveguide cable is arranged on the angled sheet-metal part.

6) The console as claimed in claim 5, wherein the fixing element comprises a jaw having an indentation and a plate, which can be screwed.

7) The console as claimed in claim 1, wherein pedestal feet, which have holes, are arranged on the lower side of the console.

8) The console as claimed in claim 1, wherein a ground strip is fixed to the upper side of the console.

9) The console as claimed in claim 1, wherein the upper side of the console has a round central region, from which rests protrude in the form of a star.

10) The console as claimed in claim 1, wherein a fixing limb for connecting a carrier system is arranged on the upper side of the console.

11) The console as claimed in claim 10, wherein the fixing limb is screwed to the ground plate and the console.
